(19) United States
(12) Patent Application Publication
(10) Pub. No.: US 2017/0274352 A1
(43) Pub. Date: Sep. 28, 2017

(54) PROCESS FOR FILTRATION ENHANCEMENT OF AQUEOUS DISPERSIONS

(71) Applicant: Solenis Technologies, L.P., Schaffhausen (CH)

(72) Inventors: Michael J. Bluemle, Wilmington, DE (US); Lawrence J. Andermann, Wilmington, DE (US); Jeffrey H. Peltier, Wilmington, PA (US)

(21) Appl. No.: 15/619,076

(22) Filed: Jun. 9, 2017

Related U.S. Application Data
(62) Division of application No. 14/026,459, filed on Sep. 13, 2013.

(51) Int. Cl. B01J 20/26; B01J 20/24; B01J 20/04; C02F 1/56; C02F 1/52

(52) U.S. Cl. CPC B01J 20/261; C02F 1/56; C02F 1/5245; B01J 20/04; B01J 20/24; B01J 20/262; C02F 2103/10

(57) ABSTRACT

A method for enhancing filtration performance in separating solids from liquids in an aqueous dispersion comprising a solids phase and a liquid phase in a two-step process having a physical separation step and a filtration step comprising adding at least one filtration aid promoter and at least one synthetic polymer to the aqueous dispersion during and/or before the physical separation step resulting in a liquid-solid separation and filtering the liquid from the solid. The method may be applied in mining operations for the filtering of mining slurries.

### BACKGROUND OF THE INVENTION

This application claims the benefit of U.S. patent application Ser. No. 14/026,459, filed 13 Sep. 2013, which claims benefit of Provisional application No. 61/702,774, filed 19 Sep. 2012, the entire contents of which are hereby incorporated by reference.

### Field of the Invention

The invention relates to compositions and methods which enhance the filtration of aqueous dispersions. For example, in dewatering aqueous mineral slurries by adding a filtration aid promoter and synthetic polymer to the aqueous dispersion prior to filtration. In particular, the method enhances filtration when the filtration aid promoter and synthetic polymer are added prior to and/or during separation of solids phase from liquid phase in an aqueous slurry but prior to the filtration of the concentrated aqueous phase. The compositions and methods have particular application with respect to mining slurries.

### The Related Art

Conventional metallurgical processing techniques involve the separation of valuable minerals from the low value gangue in an aqueous medium. Mineral ores go through numerous processing operations to extract valuable constituents. Processing operations, such as crushing, grinding, sieving, cycloning, and flotation are used to enrich the most desirable components to form a mineral concentrate. Valuable minerals that are concentrated include precious metals (gold, silver, platinum), base metals (copper, nickel, zinc, lead, molybdenum), iron and coal. Once concentrated the aqueous mineral slurry is typically subjected to a mechanical dewatering process to remove liquid water from the mineral slurry concentrate. Excess moisture content in the dewatered mineral slurry may have deleterious effects on the downstream process operations, which may include pelletizing, autoclaving, calcining, or smelting, or greatly increase transportation costs.

Wet processing is used because this type of process improves efficiency, increases recovery, lowers costs, and minimizes air pollution. Ore enrichment techniques, such as flotation processes, produce a mineral concentrate that contains an excessive amount of water. In order to reduce energy costs associated with downstream operations and decrease transportation costs, as much of the water should be removed as possible. Generally, dewatering is accomplished with gravity thickeners, clarifiers, hydrocyclones, vacuum filtration and/or pressure filtration.

For example, the mineral slurry may be dewatered in a two step method comprising liquid solid separation, such as in a gravity thickener, clarifier and/or hydrocyclone, which produces a liquid phase, supernatant, and a concentrate or underflow. The concentrate or underflow comprises the valuable minerals which require further dewatering which occurs in a second step in which the concentrate or underflow is filtered, such as through vacuum filtration and/or pressure filtration.

Gravity thickeners, clarifiers and hydrocyclones are typically used to dewater mineral concentrates with the aid of coagulating and flocculating agents. While beneficial to sedimentation, these agents hinder further downstream mechanical dewatering.

All parts and percentages set forth herein are on a weight by weight basis unless otherwise specified. Mw is the weight average molecular weight as determined by SEC-MALLS analysis. MALLS shall mean and refer to multi-angular laser light scattering. SEC-MALLS shall mean and refer to a size exclusion chromatography technique using MALLS to determine Mw.

### SUMMARY OF THE INVENTION

The invention pertains to compositions comprising filtration aid promoters and synthetic polymer. These compositions are applied in methods for separating solids from liquids in aqueous dispersions comprising a filtration step. The filtration aid and synthetic polymer are added to the aqueous dispersion prior to and/or during the physical separation of a solid phase from a liquid phase, such as allowing the solids to settle from the dispersion. The solid phase may then be filtered. Filtration aid promoters include natural polymers, semi-natural polymers, coagulants and the like and combinations thereof.

Typically, the composition is applied in dewatering processes in mining operations. Such dewatering processes generally comprise two steps, the first step involving liquid solid separation and the second separate step involving filtration of concentrate or underflow from the liquid solid separation step. The liquid solid separation is typically accomplished with gravity thickeners, clarifiers, hydrocyclones and the like. Filtration is generally accomplished by vacuum filtration, pressure filtration and the like. The filtration aid promoter and synthetic polymer are added to a mineral slurry prior to the liquid solid separation step, during the liquid solid separation step or both during and prior to the liquid solid separation step. The liquid solid separation step produces concentrate or underflow which requires further dewatering through a separate filtration step.

Without being bound to any theory, the inventors believe that the application of the filtration aid promoter and synthetic polymer prior to and/or during the physical separation step affects the rheology of the resulting concentrate (or underflow) which enhances the filtration process in the subsequent filtration step. For example, the combination of the filtration aid promoter and synthetic polymer when applied prior to and/or during the liquid solid separation step in mining operations increases the production of the filter cakes resulting from the separate filtration step.

### DETAILED DESCRIPTION OF THE INVENTION

Among the natural polymers that can be used for the filtration aid promoter are polysaccharides, such as potato starch, xanthan gums, guars, dextran, cellulose derivatives and glycosaminoglycans. Typically, the polydispersity index (“PDI”) of the polysaccharide is from about 1.0 to about 10.0, more typically from about 1.1 to about 9.0, and most typically from about 1.2 to about 8.0. Persons of ordinary skill in these arts, after reading this disclosure, will appreciate that all ranges and values within these explicitly stated ranges are contemplated.

The natural polymer preferably comprises dextran, which is generally available from various suppliers. Dextran having a Mw of from about 5,000 to about 40,000,000, preferably from about 50,000 to about 25,000,000 and more preferably from about 200,000 to about 10,000,000, may be used. Persons of ordinary skill in these arts, after reading this disclosure, will appreciate that all ranges and values within these explicitly stated ranges are contemplated. Natural polymers sold under the trade names ZALTA® VM 1120 and ZALTA VM 1122, both available from Ashland may be used.

The semi-natural polymers include lignosulfonates, such as calcium lignosulfonate, and chemically modified polysaccharides. Modified polysaccharides typically useful in the process include modified starches, such as cationic starch; modified guar gum, such as cationic guar gum; and modified celluloses such as anionic carboxymethyl cellulose and hydroxyethyl cellulose. Combinations of semi-natural polymers may be used.

The coagulant is typically selected from an inorganic coagulant, organic coagulant and combinations thereof. Inorganic coagulants include aluminum sulfate, aluminum chloride, polyaluminum chloride, aluminum chlorohydrate, ferric chloride, ferric sulfate, ferrous sulfate and sodium aluminate. Organic coagulants include polymers formed from the monomers diallyl dimethyl ammonium chloride, ethylene imine and the comonomers of epichlorohydrin and dimethylamine. Inorganic coagulants also include cationically-modified tannins and melamine formaldehyde. Such coagulants include CHARGEPAC® 60 available from Ashland Inc., Wilmington, Del., U.S.A. (“Ashland”), CHARGEPAC® 7 available from Ashland and AMERSEP® 5320 available from Ashland.

Synthetic polymers include water-soluble anionic, cationic, nonionic polymers, and amphoteric polymers. For purpose of this disclosure, synthetic polymer shall include copolymers and terpolymers, as well as homopolymers. Typically the synthetic polymer has a Mw of from about 40,000 to about 25,000,000, and persons of ordinary skill in these arts, after reading this disclosure, will appreciate that all ranges and values within these explicitly stated ranges are contemplated. The synthetic polymer may be linear, branched, or cross-linked. Typically, the synthetic polymer functions as a flocculant.

Nonionic polymers include polymers formed from one or more water soluble ethylenically unsaturated nonionic monomers, for instance acrylamide, methacrylamide, hydroxyethyl acrylate and N-vinylpyrrolidone, preferably acrylamide. Nonionic polymers also include alkoxylated multifunctional alcohols.

Cationic polymers are formed from one or more ethylenically unsaturated cationic monomers optionally with one or more of the nonionic monomers mentioned previously. The cationic polymer may also be amphoteric provided such that there are predominantly more cationic groups than anionic groups. The cationic monomers include dialkylamino alkyl (meth) acrylates, dialkylamino alkyl (meth) acrylamides, including acid addition and quaternary ammonium salts thereof, diallyl dimethyl ammonium chloride. Typical cationic monomers include the methyl chloride quaternary ammonium salts of dimethylamino ethyl acrylate and dimethyl aminoethyl methacrylate. Of particular interest are the copolymer of acrylamide with the methyl chloride quaternary ammonium salts of dimethylamino ethyl acrylate (ADAME); the copolymer of acrylamide and acrylamidopropyl trimethyl ammonium chloride (APTAC); and the copolymer of acrylamide and acryloloxyethyl trimethyl ammonium chloride (AETAC); and the copolymer of epichlorohydrin and dimethylamine.

The anionic synthetic polymers are formed from one or more ethylenically unsaturated anionic monomers or a blend of one or more anionic monomers with one or more of the nonionic monomers mentioned previously. The anionic monomers include acrylic acid, methacrylic acid, maleic acid, crotonic acid, itaconic acid, vinyl sulfonic acid, allyl sulfonic acid, 2-acrylamido-2-methylpropane sulfonic acid (AMPS), acrylamide, mixtures thereof, and salts thereof.

Of particular interest are copolymers and/or terpolymers of monomers selected from the group consisting of acrylamide, AMPS, acrylic acid, and (meth)acrylic acid. For example, the anionic polymer may be selected from the group consisting of copolymers derived from 2-acrylamido 2-methylpropane sulfonic acid, copolymers of acrylic acid and acrylamide, homopolymers of acrylic acid, homopolymers of acrylamide, and combinations thereof. Typically used as anionic polymer are the copolymer of sodium acrylate and acrylamide and the copolymer of acrylic acid and acrylamide.

Also of particular interest are copolymers of AMPS and acrylamide wherein the mole percent of AMPS is from about 10 mole percent to about 25 mole percent, and terpolymers of AMPS, acrylamide, and acrylic acid wherein the mole percent of AMPS is from about 10 mole percent to about 30 mole percent, the mole percent of acrylamide is from about 40 mole percent to about 60 mole percent, and the mole percent of acrylic acid is from about 20 mole percent to about 40 mole percent. Otherwise, homopolymers of acrylic acid or copolymers of acrylic acid and acrylamide are of particular interest.

The filtration aid promoter and synthetic polymer are applied in methods for separating solids from a liquid dispersion. This process comprises the steps of adding the filtration aid promoter and synthetic polymer to an aqueous dispersion of solids in liquids prior to and/or during the physical separation of the solids from the liquid resulting in a concentrate comprising solids, recovering the concentrate and then filtering the concentrate. Enhanced filtration is achieved with this method. Physical separation can occur by allowing the solids to settle from the liquid through force of gravity, optionally with flocculation and/or agglomeration of the solid particles.

The method may be applied in mining operations. A method for dewatering mining slurries, in particular enhanced filtration performance, in a two step process having a liquid solid separation step and a filtration step comprises adding at least one filtration aid promoter and at least one synthetic polymer to the mining slurry during or before, or both during and before, the liquid solid separation step and then filtering the concentrate or underflow from the liquid solid separation step. The minerals include gold, phosphate, silver, platinum, copper, nickel, zinc, lead, molybdenum, iron, coal and the like. Typically, the liquid solid separation step is performed in a means for separating liquids from solids, such as a gravity thickener, clarifier or hydrocyclone and the filtration aid promoter and synthetic polymer may added to and/or prior to such means. The filtration step is generally conducted in a means for filtering solids from liquids, such as a filter press or vacuum filter.

### EXAMPLES

### Preparation of Aqueous Dispersions for Filtration

Unless otherwise indicated, aqueous dispersion samples were prepared by adding 1000 mL of an aqueous dispersion to a graduated cylinder, where it was treated by adding the specified components of the filtration aid promoter (i.e. coagulant, natural polymer and/or semi-natural polymer) as set forth in Table I, and tamping the filtration aid promoter into the dispersion three times with a plunger having perforated holes.

Next, the synthetic polymer was added to the aqueous dispersion using the same mixing technique and number of tamps. Synthetic Polymer A used in the Examples is an anionic copolymer available under the trade name FLOPAM® AN 113 available from SNF Floerger, Andrézieu, France. The suppliers and/or trade names for the synthetic polymer and the component(s) of the filtration aid promoter are set forth in Table IA.

The aqueous dispersion settled and was allowed to rest in the graduated cylinder for 72 hours. The supernatant was then siphoned out of the graduated cylinder until there were only concentrated solids, i.e. the concentrate, left in the cylinder. The resulting slurries were quantitatively transferred into appropriately sized beakers for filtration.

### Pressure Filtration

Unless otherwise indicated, filtration of concentrated slurries was conducted at 30 psig with a FANN® Filter Press (FANN Instrument Company, Houston, Tex., U.S.A.) and hardened, low-ash FANN filter paper with a particle size retention range of 2-5 μm. Prior to transferring to the filter press, samples were first hand-mixed for 15 seconds. After transferring the sample, the filter press was sealed and pressurized air was applied to the filter press. The volume of liquid removed from the concentrated sample was measured as a function of time after application of the pressurized air.

TABLE I

| Sample | Composition | M_{w} (g/mol) | Ionicity |
|---|---|---|---|
| Synthetic Polymer A | | 1,200,000 | Anionic |
| Coagulant A | | | Cationic |
| Coagulant B | | | Cationic |
| Coagulant C | | | Cationic |
| Natural Polymer A | Dextran Syrup | 11,600,000 | Non-ionic |
| Natural Polymer B | Dextran Syrup | 9,200,000 | Non-ionic |
| Natural Polymer C | Dextran Syrup | 24,600,000 | Non-ionic |
| Natural Polymer D | Dextran Syrup | 28,700,000 | Non-ionic |
| Natural Polymer E | Dextran Syrup | 1,360,000 | Non-ionic |
| Natural Polymer F | Dextran Syrup | 4,910,000 | Non-ionic |
| Natural Polymer G | Dextran | 677,000 | Non-ionic |
| Natural Polymer H | Dextran | 500,000 (1) | Non-ionic |
| Natural Polymer I | Dextran | 44,000 | Non-ionic |
| Natural Polymer J | Dextran | 40,000 (1) | Non-ionic |
| Semi-natural Polymer A | Cationic Guar | | Cationic |
| Semi-natural Polymer B | Cationic Guar | | Cationic |

Note
(1) Nominal molecular weight.

TABLE IA

| Sample | Tradename |
|---|---|
| Synthetic Polymer A | SNF Flopam AN 113 |
| Coagulant A | Chargepac 7 |
| Coagulant B | Amersep 5320 |
| Coagulant C | Chargepac 60 |
| Natural Polymer A | Zalta VM 1120 |
| Natural Polymer B | Zalta VM 1120 |
| Natural Polymer C | Zalta VM 1122 |
| Natural Polymer D | Zalta VM 1122 |
| Natural Polymer E | Zalta VM 1120 |
| Natural Polymer F | Zalta VM 1122 |
| Natural Polymer G | Zalta VM 1120 |
| Natural Polymer H | Zalta VM 1122 |
| Natural Polymer I | Zalta VM 1120 |
| Natural Polymer J | Zalta VM 1122 |
| Semi-natural Polymer A | N-Hance BF17 |
| Semi-natural Polymer B | N-Hance 3215 |

### Examples 1-16 and Comparative Examples A and B

These examples illustrate the use of natural polymers of Table I with a synthetic polymer (Synthetic Polymer A) to enhance the filtration of an aqueous dispersion containing gold concentrate. Comparative Examples A and B used only Synthetic Polymer A as the polymer treatment. For Examples 6, 15 and 16, an additional 30 grams per ton of Natural Polymer A was added prior to filtration.

In all examples, except for Examples 4 and 5, the natural polymers of varying molecular weight were added first followed by the addition of Synthetic Polymer A. The amount of solids in the aqueous dispersion was 47.1 grams per liter prior to settling. The dosage of flocculant (Synthetic Polymer A) was kept constant at 53.1 grams per ton, while the ratio of natural polymer to synthetic polymer varied from 0 to 100%. The natural polymers used and the ratio of natural polymer to Synthetic Polymer A are set forth in Table II. The times for filtering 10 and 20 mL were measured. The filtration rates were then calculated and compared to the corresponding comparative example to provide a percentage measure of the increase in filtration rate (% 10 mLs and % 20 mLs). These values and the average of % 10 mLs and % 20 mLs are set forth in Table II.

The data in Table II demonstrate that the filtration rate of aqueous dispersion containing gold concentrate increased when natural polymers were used in conjunction with Synthetic Polymer A. Examples 4 and 5 indicate that order of addition (Synthetic Polymer A dosed prior to Natural Polymer A) does not negatively impact the filtration rate of the aqueous dispersion. Examples 6, 15 and 16 demonstrate that additional Natural Polymer A does not positively or negatively impact the filtration rate.

TABLE II

| Example # | Substrate | Solids (g/L) | Reagent(s) | Ratio |
|---|---|---|---|---|
| A | Gold Concentrate | 47.1 | Synthetic Polymer A Only | 0% |
| 1 | Gold Concentrate | 47.1 | Natural Polymer A plus Synthetic Polymer A | 25% |
| 2 | Gold Concentrate | 47.1 | Natural Polymer A plus Synthetic Polymer A | 75% |
| 3 | Gold Concentrate | 47.1 | Natural Polymer A plus Synthetic Polymer A | 100% |
| 4 | Gold Concentrate | 47.1 | Synthetic Polymer A plus Natural Polymer A | 25% |
| 5 | Gold Concentrate | 47.1 | Synthetic Polymer A plus Natural Polymer A | 50% |
| 6 | Gold Concentrate | 47.1 | Natural Polymer A plus Synthetic Polymer A (1) | 50% |
| B | Gold Concentrate | 47.1 | Synthetic Polymer A Only | 0% |
| 7 | Gold Concentrate | 47.1 | Natural Polymer B plus Synthetic Polymer A | 25% |
| 8 | Gold Concentrate | 47.1 | Natural Polymer B plus Synthetic Polymer A | 37.5% |
| 9 | Gold Concentrate | 47.1 | Natural Polymer B plus Synthetic Polymer A | 50% |
| 10 | Gold Concentrate | 47.1 | Natural Polymer C plus Synthetic Polymer A | 37.5% |
| 11 | Gold Concentrate | 47.1 | Natural Polymer C plus Synthetic Polymer A | 50% |
| 12 | Gold Concentrate | 47.1 | Natural Polymer D plus Synthetic Polymer A | 25% |
| 13 | Gold Concentrate | 47.1 | Natural Polymer D plus Synthetic Polymer A | 37.5% |
| 14 | Gold Concentrate | 47.1 | Natural Polymer D plus Synthetic Polymer A | 50% |
| 15 | Gold Concentrate | 47.1 | Natural Polymer B plus Synthetic Polymer A (1) | 25% |
| 16 | Gold Concentrate | 47.1 | Natural Polymer B plus Synthetic Polymer A (1) | 37.5% |

| | Flocculant | Time for | Time for | Rate | Rate | % | % | |
|---|---|---|---|---|---|---|---|---|
| Example # | Dose (g/T) | 10 mLs (s) | 20 mLs (s) | 10 mLs | 20 mLs | 10 mLs | 20 mLs | Average |
| A | 53.1 | 21 | 78 | 0.48 | 0.26 | | | |
| 1 | 53.1 | 19 | 68 | 0.53 | 0.29 | 10.5 | 14.7 | 12.6 |
| 2 | 53.1 | 18 | 61 | 0.56 | 0.33 | 16.7 | 27.9 | 22.3 |
| 3 | 53.1 | 19 | 60 | 0.53 | 0.33 | 10.5 | 30.0 | 20.3 |
| 4 | 53.1 | 17 | 61 | 0.59 | 0.33 | 23.5 | 27.9 | 25.7 |
| 5 | 53.1 | 19 | 65 | 0.53 | 0.31 | 10.5 | 20.0 | 15.3 |
| 6 | 53.1 | 18 | 64 | 0.56 | 0.31 | 16.7 | 21.9 | 19.3 |
| B | 53.1 | 22 | 73 | 0.45 | 0.27 | | | |
| 7 | 53.1 | 18 | 64 | 0.56 | 0.31 | 22.2 | 14.1 | 18.1 |
| 8 | 53.1 | 20 | 66 | 0.50 | 0.30 | 10.0 | 10.6 | 10.3 |
| 9 | 53.1 | 18 | 65 | 0.56 | 0.31 | 22.2 | 12.3 | 17.3 |
| 10 | 53.1 | 18 | 60 | 0.56 | 0.33 | 22.2 | 21.7 | 21.9 |
| 11 | 53.1 | 18 | 62 | 0.56 | 0.32 | 22.2 | 17.7 | 20.0 |
| 12 | 53.1 | 17 | 61 | 0.59 | 0.33 | 29.4 | 19.7 | 24.5 |
| 13 | 53.1 | 19 | 66 | 0.53 | 0.30 | 15.8 | 10.6 | 13.2 |
| 14 | 53.1 | 19 | 66 | 0.53 | 0.30 | 15.8 | 10.6 | 13.2 |
| 15 | 53.1 | 18 | 69 | 0.56 | 0.29 | 22.2 | 5.8 | 14.0 |
| 16 | 53.1 | 18 | 64 | 0.56 | 0.31 | 22.2 | 14.1 | 18.1 |

Note
(1) 30 g/T of Natural Polymer A applied after settling, prior to filtration.

### Examples 17-74 and Comparative Examples C, D, E and F

These examples illustrate the use of natural polymers of Table I with a synthetic polymer (Synthetic Polymer A) to enhance the filtration of an aqueous dispersion containing phosphate ore. Comparative Examples C, D, E and F used only Synthetic Polymer A as the polymer treatment. The amount of solids in the aqueous dispersion ranged from 215.9 to 285.3 grams per liter prior to settling. The dosage of flocculant (Synthetic Polymer A) in the examples ranged from 39.4 to 52.1 grams per ton while the ratio of natural polymer to synthetic polymer varied from 0 to 200%. The natural polymers used and the ratio of natural polymer to Synthetic Polymer A are set forth in Table III. The times for filtering 15 and 30 mL were measured. The filtration rates were then calculated and compared to the corresponding comparative example to provide a percentage measure of the increase in filtration rate (% 15 mLs and % 30 mLs). These values and the average of % 15 mLs and % 30 mLs are set forth in Table III.

The data in Table III demonstrate that the filtration rate of aqueous dispersions containing phosphate ore increased when natural polymers of varying molecular weight were added to the aqueous dispersion prior to Synthetic Polymer A and allowed to settle. The data indicate that natural polymers with a wide range of molecular weights are effective filtration aid promoters over a broad range of product ratios.

TABLE III

| Example # | Substrate | Solids (g/L) | Reagent(s) | Ratio |
|---|---|---|---|---|
| C | Phosphate Ore | 285.3 | Synthetic Polymer A Only (1) | 0% |
| 17 | Phosphate Ore | 285.3 | Natural Polymer B plus Synthetic Polymer A (1) | 25% |
| 18 | Phosphate Ore | 285.3 | Natural Polymer B plus Synthetic Polymer A (1) | 50% |
| 19 | Phosphate Ore | 285.3 | Natural Polymer B plus Synthetic Polymer A | 75% |
| 20 | Phosphate Ore | 285.3 | Natural Polymer C plus Synthetic Polymer A (1) | 25% |
| 21 | Phosphate Ore | 285.3 | Natural Polymer C plus Synthetic Polymer A (1) | 50% |
| 22 | Phosphate Ore | 285.3 | Natural Polymer C plus Synthetic Polymer A | 75% |
| 23 | Phosphate Ore | 285.3 | Natural Polymer E plus Synthetic Polymer A (1) | 25% |
| 24 | Phosphate Ore | 285.3 | Natural Polymer E plus Synthetic Polymer A (1) | 50% |
| 25 | Phosphate Ore | 285.3 | Natural Polymer E plus Synthetic Polymer A | 75% |
| 26 | Phosphate Ore | 285.3 | Natural Polymer F plus Synthetic Polymer A (1) | 50% |
| 27 | Phosphate Ore | 285.3 | Natural Polymer F plus Synthetic Polymer A | 75% |
| 28 | Phosphate Ore | 285.3 | Natural Polymer G plus Synthetic Polymer A (1) | 25% |
| 29 | Phosphate Ore | 285.3 | Natural Polymer G plus Synthetic Polymer A | 50% |
| 30 | Phosphate Ore | 285.3 | Natural Polymer G plus Synthetic Polymer A (1) | 75% |
| 31 | Phosphate Ore | 285.3 | Natural Polymer H plus Synthetic Polymer A (1) | 25% |
| 32 | Phosphate Ore | 285.3 | Natural Polymer H plus Synthetic Polymer A (1) | 50% |
| 33 | Phosphate Ore | 285.3 | Natural Polymer H plus Synthetic Polymer A | 75% |
| D | Phosphate Ore | 215.9 | Synthetic Polymer A Only (2) | 0% |
| 34 | Phosphate Ore | 215.9 | Natural Polymer B plus Synthetic Polymer A (1) | 25% |
| 35 | Phosphate Ore | 215.9 | Natural Polymer B plus Synthetic Polymer A (1) | 50% |
| 36 | Phosphate Ore | 215.9 | Natural Polymer B plus Synthetic Polymer A | 75% |
| 37 | Phosphate Ore | 215.9 | Natural Polymer C plus Synthetic Polymer A (1) | 25% |
| 38 | Phosphate Ore | 215.9 | Natural Polymer C plus Synthetic Polymer A (1) | 50% |
| 39 | Phosphate Ore | 215.9 | Natural Polymer C plus Synthetic Polymer A | 75% |
| 40 | Phosphate Ore | 215.9 | Natural Polymer E plus Synthetic Polymer A (1) | 25% |
| 41 | Phosphate Ore | 215.9 | Natural Polymer E plus Synthetic Polymer A | 50% |
| 42 | Phosphate Ore | 215.9 | Natural Polymer E plus Synthetic Polymer A | 75% |
| 43 | Phosphate Ore | 215.9 | Natural Polymer F plus Synthetic Polymer A (1) | 25% |
| 44 | Phosphate Ore | 215.9 | Natural Polymer F plus Synthetic Polymer A (1) | 50% |
| 45 | Phosphate Ore | 215.9 | Natural Polymer F plus Synthetic Polymer A | 75% |
| 46 | Phosphate Ore | 215.9 | Natural Polymer I plus Synthetic Polymer A (1) | 25% |
| 47 | Phosphate Ore | 215.9 | Natural Polymer I plus Synthetic Polymer A (1) | 50% |
| 48 | Phosphate Ore | 215.9 | Natural Polymer I plus Synthetic Polymer A | 75% |
| 49 | Phosphate Ore | 215.9 | Natural Polymer J plus Synthetic Polymer A (1) | 25% |
| 50 | Phosphate Ore | 215.9 | Natural Polymer J plus Synthetic Polymer A (1) | 50% |
| 51 | Phosphate Ore | 215.9 | Natural Polymer J plus Synthetic Polymer A | 75% |
| E | Phosphate Ore | 231.1 | Synthetic Polymer A Only (1) | 0% |
| 52 | Phosphate Ore | 231.1 | Natural Polymer B plus Synthetic Polymer A (1) | 50% |
| 53 | Phosphate Ore | 231.1 | Natural Polymer B plus Synthetic Polymer A | 75% |
| 54 | Phosphate Ore | 231.1 | Natural Polymer C plus Synthetic Polymer A (1) | 25% |
| 55 | Phosphate Ore | 231.1 | Natural Polymer C plus Synthetic Polymer A (1) | 50% |
| 56 | Phosphate Ore | 231.1 | Natural Polymer C plus Synthetic Polymer A | 75% |
| 57 | Phosphate Ore | 231.1 | Natural Polymer E plus Synthetic Polymer A (1) | 50% |
| 58 | Phosphate Ore | 231.1 | Natural Polymer F plus Synthetic Polymer A (1) | 25% |
| 59 | Phosphate Ore | 231.1 | Natural Polymer F plus Synthetic Polymer A (1) | 50% |
| 60 | Phosphate Ore | 231.1 | Natural Polymer G plus Synthetic Polymer A (1) | 25% |
| 61 | Phosphate Ore | 231.1 | Natural Polymer G plus Synthetic Polymer A (1) | 50% |
| 62 | Phosphate Ore | 231.1 | Natural Polymer G plus Synthetic Polymer A | 75% |
| 63 | Phosphate Ore | 231.1 | Natural Polymer H plus Synthetic Polymer A (1) | 25% |
| 64 | Phosphate Ore | 231.1 | Natural Polymer H plus Synthetic Polymer A (1) | 50% |
| 65 | Phosphate Ore | 231.1 | Natural Polymer H plus Synthetic Polymer A | 75% |
| F | Phosphate Ore | 232.2 | Synthetic Polymer A Only (3) | 0% |
| 66 | Phosphate Ore | 232.2 | Natural Polymer C plus Synthetic Polymer A (1) | 50% |
| 67 | Phosphate Ore | 232.2 | Natural Polymer C plus Synthetic Polymer A (1) | 100% |
| 68 | Phosphate Ore | 232.2 | Natural Polymer C plus Synthetic Polymer A (1) | 150% |
| 69 | Phosphate Ore | 232.2 | Natural Polymer C plus Synthetic Polymer A | 200% |
| 70 | Phosphate Ore | 232.2 | Natural Polymer E plus Synthetic Polymer A (1) | 100% |
| 71 | Phosphate Ore | 232.2 | Natural Polymer E plus Synthetic Polymer A (1) | 150% |
| 72 | Phosphate Ore | 232.2 | Natural Polymer F plus Synthetic Polymer A (1) | 100% |
| 73 | Phosphate Ore | 232.2 | Natural Polymer F plus Synthetic Polymer A (1) | 150% |
| 74 | Phosphate Ore | 232.2 | Natural Polymer F plus Synthetic Polymer A | 200% |

| | Flocculant | Time for | Time for | Rate | Rate | % | % | |
|---|---|---|---|---|---|---|---|---|
| Example # | Dose (g/T) | 15 mLs (s) | 30 mLs (s) | 15 mLs | 30 mLs | 15 mLs | 30 mLs | Average |
| C | 39.4 | 41 | 95 | 0.37 | 0.32 | | | |
| 17 | 39.4 | 37 | 73 | 0.41 | 0.41 | 9.5 | 30.3 | 19.9 |
| 18 | 39.4 | 37 | 79 | 0.41 | 0.38 | 11.0 | 19.6 | 15.3 |
| 19 | 39.4 | 28 | 61 | 0.54 | 0.49 | 44.6 | 54.9 | 49.8 |
| 20 | 39.4 | 32 | 69 | 0.47 | 0.43 | 26.6 | 37.0 | 31.8 |
| 21 | 39.4 | 29 | 66 | 0.52 | 0.46 | 39.7 | 44.3 | 42.0 |
| 22 | 39.4 | 31 | 71 | 0.48 | 0.42 | 30.6 | 33.1 | 31.9 |
| 23 | 39.4 | 34 | 77 | 0.44 | 0.39 | 19.1 | 23.5 | 21.3 |
| 24 | 39.4 | 38 | 82 | 0.40 | 0.37 | 8.0 | 15.2 | 11.6 |
| 25 | 39.4 | 29 | 66 | 0.52 | 0.45 | 39.7 | 43.2 | 41.4 |
| 26 | 39.4 | 31 | 75 | 0.48 | 0.40 | 30.6 | 26.8 | 28.7 |
| 27 | 39.4 | 35 | 78 | 0.43 | 0.38 | 15.7 | 21.2 | 18.4 |
| 28 | 39.4 | 33 | 72 | 0.46 | 0.42 | 24.6 | 32.2 | 28.4 |
| 29 | 39.4 | 36 | 79 | 0.42 | 0.38 | 12.5 | 19.6 | 16.1 |
| 30 | 39.4 | 30 | 71 | 0.50 | 0.42 | 35.0 | 33.1 | 34.0 |
| 31 | 39.4 | 33 | 71 | 0.46 | 0.43 | 24.6 | 34.0 | 29.3 |
| 32 | 39.4 | 33 | 75 | 0.45 | 0.40 | 22.7 | 26.0 | 24.4 |
| 33 | 39.4 | 34 | 77 | 0.44 | 0.39 | 19.1 | 22.7 | 20.9 |
| D | 52.1 | 58 | 157 | 0.26 | 0.19 | | | |
| 34 | 52.1 | 40.5 | 84.5 | 0.37 | 0.36 | 43.2 | 85.4 | 64.3 |
| 35 | 52.1 | 33.5 | 70 | 0.45 | 0.43 | 73.1 | 123.8 | 98.5 |
| 36 | 52.1 | 31 | 68 | 0.48 | 0.44 | 87.1 | 130.4 | 108.7 |
| 37 | 52.1 | 29.5 | 62 | 0.51 | 0.48 | 96.6 | 152.7 | 124.6 |
| 38 | 52.1 | 29.5 | 61.5 | 0.51 | 0.49 | 96.6 | 154.7 | 125.7 |
| 39 | 52.1 | 28 | 60 | 0.54 | 0.50 | 107.1 | 161.1 | 134.1 |
| 40 | 52.1 | 28 | 59.5 | 0.54 | 0.50 | 107.1 | 163.3 | 135.2 |
| 41 | 52.1 | 31 | 65.5 | 0.48 | 0.46 | 87.1 | 139.2 | 113.1 |
| 42 | 52.1 | 20 | 64 | 0.75 | 0.47 | 190.0 | 144.8 | 167.4 |
| 43 | 52.1 | 24 | 63 | 0.63 | 0.48 | 141.7 | 148.7 | 145.2 |
| 44 | 52.1 | 28 | 72.5 | 0.54 | 0.41 | 107.1 | 116.1 | 111.6 |
| 45 | 52.1 | 32 | 67 | 0.47 | 0.45 | 81.3 | 133.8 | 107.5 |
| 46 | 52.1 | 37.5 | 81 | 0.40 | 0.37 | 54.7 | 93.4 | 74.0 |
| 47 | 52.1 | 32 | 68.5 | 0.47 | 0.44 | 81.3 | 128.7 | 105.0 |
| 48 | 52.1 | 34 | 73 | 0.44 | 0.41 | 70.6 | 114.6 | 92.6 |
| 49 | 52.1 | 38.5 | 87.5 | 0.39 | 0.34 | 50.6 | 79.0 | 64.8 |
| 50 | 52.1 | 35.5 | 75 | 0.42 | 0.40 | 63.4 | 108.9 | 86.1 |
| 51 | 52.1 | 36 | 73 | 0.42 | 0.41 | 61.1 | 114.6 | 87.9 |
| E | 48.7 | 31 | 68 | 0.49 | 0.44 | | | |
| 52 | 48.7 | 28 | 57 | 0.55 | 0.53 | 10.9 | 20.4 | 15.6 |
| 53 | 48.7 | 27 | 57 | 0.56 | 0.53 | 13.0 | 19.3 | 16.1 |
| 54 | 48.7 | 25 | 54 | 0.60 | 0.56 | 22.0 | 27.1 | 24.6 |
| 55 | 48.7 | 21 | 45 | 0.73 | 0.67 | 48.8 | 52.8 | 50.8 |
| 56 | 48.7 | 22 | 45 | 0.68 | 0.67 | 38.6 | 51.1 | 44.9 |
| 57 | 48.7 | 25 | 53 | 0.61 | 0.57 | 24.5 | 28.3 | 26.4 |
| 58 | 48.7 | 29 | 60 | 0.53 | 0.50 | 7.0 | 13.3 | 10.2 |
| 59 | 48.7 | 23 | 49 | 0.67 | 0.62 | 35.6 | 40.2 | 37.9 |
| 60 | 48.7 | 25 | 54 | 0.60 | 0.56 | 22.0 | 27.1 | 24.6 |
| 61 | 48.7 | 22 | 45 | 0.70 | 0.67 | 41.9 | 51.1 | 46.5 |
| 62 | 48.7 | 19 | 48 | 0.79 | 0.63 | 60.5 | 41.7 | 51.1 |
| 63 | 48.7 | 23 | 58 | 0.67 | 0.52 | 35.6 | 18.3 | 26.9 |
| 64 | 48.7 | 26 | 56 | 0.59 | 0.54 | 19.6 | 21.4 | 20.5 |
| 65 | 48.7 | 21 | 48 | 0.71 | 0.63 | 45.2 | 41.7 | 43.5 |
| F | 48.4 | 26 | 55 | 0.57 | 0.54 | | | |
| 66 | 48.4 | 23 | 48 | 0.67 | 0.63 | 17.3 | 15.0 | 16.2 |
| 67 | 48.4 | 23 | 50 | 0.67 | 0.61 | 17.3 | 11.5 | 14.4 |
| 68 | 48.4 | 22 | 47 | 0.68 | 0.65 | 20.0 | 18.7 | 19.4 |
| 69 | 48.4 | 18 | 38 | 0.83 | 0.79 | 46.7 | 45.3 | 46.0 |
| 70 | 48.4 | 23 | 48 | 0.65 | 0.63 | 14.8 | 16.2 | 15.5 |
| 71 | 48.4 | 22 | 47 | 0.70 | 0.64 | 22.8 | 17.4 | 20.1 |
| 72 | 48.4 | 21 | 43 | 0.73 | 0.71 | 28.8 | 29.9 | 29.3 |
| 73 | 48.4 | 21 | 43 | 0.71 | 0.70 | 25.7 | 28.4 | 27.0 |
| 74 | 48.4 | 20 | 43 | 0.75 | 0.70 | 32.0 | 28.4 | 30.2 |

Note
(1) Average of two experiments.
(2) Average of three experiments.
(3) Average of four experiments.

### Examples 75-94 and Comparative Examples G and H

These examples illustrate the use of natural and/or semi-natural polymers of Table I with a synthetic polymer (Synthetic Polymer A) to enhance the filtration of an aqueous dispersion containing gold concentrate. Comparative Examples G and H used only Synthetic Polymer A as the polymer treatment. Examples 92-94 used both natural and semi-natural polymers, which were applied prior to Synthetic Polymer A. The amount of solids in the aqueous dispersion was 200.6 or 209.1 grams per liter prior to settling. The dosage of flocculant (Synthetic Polymer A) in the examples was 112.2 or 143.5 grams per ton, while the ratio of natural or semi-natural polymer to synthetic polymer varied from 0 to 100%. The natural and semi-natural polymers used and the ratio of natural and semi-natural polymers to Synthetic Polymer A are set forth in Table IV. The times for filtering 30 and 60 mL were measured. The filtration rates were then calculated and compared to the corresponding comparative example to provide a percentage measure of the increase in filtration rate (% 30 mLs and % 60 mLs). These values and the average of % 30 mLs and % 60 mLs are set forth in Table IV.

TABLE IV

| Example # | Substrate | Solids (g/L) | Reagent(s) | Ratio |
|---|---|---|---|---|
| G | Gold Concentrate | 209.1 | Synthetic Polymer A Only (2) | 0% |
| 75 | Gold Concentrate | 209.1 | Natural Polymer B plus Synthetic Polymer A | 75% |
| 76 | Gold Concentrate | 209.1 | Natural Polymer C plus Synthetic Polymer A (1) | 50% |
| 77 | Gold Concentrate | 209.1 | Natural Polymer C plus Synthetic Polymer A | 75% |
| 78 | Gold Concentrate | 209.1 | Natural Polymer F plus Synthetic Polymer A (1) | 50% |
| 79 | Gold Concentrate | 209.1 | Natural Polymer F plus Synthetic Polymer A | 75% |
| 80 | Gold Concentrate | 209.1 | Natural Polymer J plus Synthetic Polymer A (1) | 50% |
| 81 | Gold Concentrate | 209.1 | Natural Polymer J plus Synthetic Polymer A | 75% |
| H | Gold Concentrate | 200.6 | Synthetic Polymer A Only | 0% |
| 82 | Gold Concentrate | 200.6 | Natural Polymer B plus Synthetic Polymer A | 25% |
| 83 | Gold Concentrate | 200.6 | Natural Polymer B plus Synthetic Polymer A (1) | 75% |
| 84 | Gold Concentrate | 200.6 | Natural Polymer B plus Synthetic Polymer A | 100% |
| 85 | Gold Concentrate | 200.6 | Semi-natural Polymer A plus Synthetic Polymer A | 25% |
| 86 | Gold Concentrate | 200.6 | Semi-natural Polymer A plus Synthetic Polymer A (1) | 50% |
| 87 | Gold Concentrate | 200.6 | Semi-natural Polymer A plus Synthetic Polymer A (1) | 75% |
| 88 | Gold Concentrate | 200.6 | Semi-natural Polymer A plus Synthetic Polymer A | 100% |
| 89 | Gold Concentrate | 200.6 | Semi-natural Polymer B plus Synthetic Polymer A (1) | 50% |
| 90 | Gold Concentrate | 200.6 | Semi-natural Polymer B plus Synthetic Polymer A (1) | 75% |
| 91 | Gold Concentrate | 200.6 | Semi-natural Polymer B plus Synthetic Polymer A | 100% |
| 92 | Gold Concentrate | 200.6 | Natural Polymer B + Semi-natural Polymer A | 25% |
| | | | plus Synthetic Polymer A | |
| 93 | Gold Concentrate | 200.6 | Natural Polymer B + Semi-natural Polymer B | 75% |
| | | | plus Synthetic Polymer A (1) | |
| 94 | Gold Concentrate | 200.6 | Natural Polymer B + Semi-natural Polymer B | 100% |
| | | | plus Synthetic Polymer A | |

| | Flocculant | Time for | Time for | Rate | Rate | % | % | |
|---|---|---|---|---|---|---|---|---|
| Example # | Dose (g/T) | 30 mLs (s) | 60 mLs (s) | 30 mLs | 60 mLs | 30 mLs | 60 mLs | Average |
| G | 143.5 | 122 | 456 | 0.25 | 0.13 | | | |
| 75 | 143.5 | 110 | 416 | 0.27 | 0.14 | 10.9 | 9.7 | 10.3 |
| 76 | 143.5 | 108 | 401 | 0.28 | 0.15 | 13.5 | 13.9 | 13.7 |
| 77 | 143.5 | 109 | 405 | 0.28 | 0.15 | 11.9 | 12.7 | 12.3 |
| 78 | 143.5 | 107 | 400 | 0.28 | 0.15 | 14.0 | 14.1 | 14.1 |
| 79 | 143.5 | 108 | 400 | 0.28 | 0.15 | 13.0 | 14.1 | 13.5 |
| 80 | 143.5 | 107 | 405 | 0.28 | 0.15 | 14.6 | 12.7 | 13.6 |
| 81 | 143.5 | 107 | 415 | 0.28 | 0.14 | 14.0 | 10.0 | 12.0 |
| H | 112.2 | 56 | 192 | 0.27 | 0.16 | | | |
| 82 | 112.2 | 49 | 170 | 0.31 | 0.18 | 14.3 | 12.9 | 13.6 |
| 83 | 112.2 | 51 | 176 | 0.30 | 0.17 | 10.9 | 9.4 | 10.1 |
| 84 | 112.2 | 48 | 163 | 0.31 | 0.18 | 16.7 | 17.8 | 17.2 |
| 85 | 112.2 | 47 | 168 | 0.32 | 0.18 | 19.1 | 14.3 | 16.7 |
| 86 | 112.2 | 50 | 175 | 0.30 | 0.17 | 12.0 | 10.0 | 11.0 |
| 87 | 112.2 | 48 | 169 | 0.31 | 0.18 | 16.7 | 13.6 | 15.1 |
| 88 | 112.2 | 45 | 155 | 0.33 | 0.19 | 24.4 | 23.9 | 24.2 |
| 89 | 112.2 | 50 | 173 | 0.30 | 0.17 | 12.0 | 11.3 | 11.7 |
| 90 | 112.2 | 48 | 166 | 0.31 | 0.18 | 16.7 | 15.7 | 16.2 |
| 91 | 112.2 | 41 | 144 | 0.37 | 0.21 | 36.6 | 33.3 | 35.0 |
| 92 | 112.2 | 49 | 171 | 0.31 | 0.18 | 14.3 | 12.3 | 13.3 |
| 93 | 112.2 | 42 | 163 | 0.36 | 0.18 | 33.3 | 18.2 | 25.7 |
| 94 | 112.2 | 49 | 173 | 0.31 | 0.17 | 14.3 | 11.0 | 12.6 |

Note
(1) Average of two experiments.
(2) Average of three experiments.

The data in Table IV demonstrate that the filtration rate of aqueous dispersions containing gold concentrate increased when natural polymers of varying molecular weight were added to the aqueous dispersion prior to Synthetic Polymer A and allowed to settle. Semi-natural polymers were also effective filtration enhancers when used alone or in combination with Natural Polymer B.

### Examples 95-106 and Comparative Example I

These examples illustrate the use of natural or semi-natural polymers with coagulants of Table I with a synthetic polymer (Synthetic Polymer A) to enhance the filtration of an aqueous dispersion containing gold concentrate. Comparative Example I used only Synthetic Polymer A as the polymer treatment. Examples 95-100 and 104-109 used natural or semi-natural polymers in combination with a coagulant, which were applied prior to Synthetic Polymer A. In Examples 108 and 109, Natural Polymer B and the coagulant were mixed together prior to dosing. The amount of solids in the aqueous dispersion was 208.1 grams per liter prior to settling. The dosage of flocculant (Synthetic Polymer A) in the examples was 144.1 grams per ton, while the ratio of natural or semi-natural polymers with coagulant to synthetic polymer varied from 0 to 100%. The natural or semi-natural polymers with coagulant used and the ratio of such natural or semi-natural polymers with coagulant to Synthetic Polymer A are set forth in Table V. The times for filtering 30 and 60 mL were measured. The filtration rates were then calculated and compared to the corresponding comparative example to provide a percentage measure of the increase in filtration rate (% 30 mLs and % 60 mLs). These values and the average of % 30 mLs and % 60 mLs are set forth in Table V.

The data in Table V demonstrate that the filtration rate of aqueous dispersions containing gold concentrate increased when Natural Polymer B or Semi-natural Polymer B in combination with coagulants were added to the aqueous dispersion prior to Synthetic Polymer A and allowed to settle. Combinations of Natural Polymer B and Coagulant A or B were effective filtration enhancers whether mixed or dosed separately.

TABLE V

| Example # | Substrate | Solids (g/L) | Reagent(s) |
|---|---|---|---|
| I | Gold Concentrate | 208.1 | Synthetic Polymer A Only (1) |
| 95 | Gold Concentrate | 208.1 | Natural Polymer B + Coagulant A plus Synthetic Polymer A |
| 96 | Gold Concentrate | 208.1 | Natural Polymer B + Coagulant A plus Synthetic Polymer A |
| 97 | Gold Concentrate | 208.1 | Natural Polymer B + Coagulant A plus Synthetic Polymer A |
| 98 | Gold Concentrate | 208.1 | Natural Polymer B + Coagulant B plus Synthetic Polymer A |
| 99 | Gold Concentrate | 208.1 | Natural Polymer B + Coagulant B plus Synthetic Polymer A |
| 100 | Gold Concentrate | 208.1 | Natural Polymer B + Coagulant C plus Synthetic Polymer A |
| 101 | Gold Concentrate | 208.1 | Semi-natural Polymer B plus Synthetic Polymer A |
| 102 | Gold Concentrate | 208.1 | Semi-natural Polymer B plus Synthetic Polymer A |
| 103 | Gold Concentrate | 208.1 | Semi-natural Polymer B plus Synthetic Polymer A |
| 104 | Gold Concentrate | 208.1 | Semi-natural Polymer B + Coagulant A plus Synthetic Polymer A |
| 105 | Gold Concentrate | 208.1 | Semi-natural Polymer B + Coagulant A plus Synthetic Polymer A |
| 106 | Gold Concentrate | 208.1 | Semi-natural Polymer B + Coagulant A plus Synthetic Polymer A |
| 107 | Gold Concentrate | 208.1 | Semi-natural Polymer B + Coagulant C plus Synthetic Polymer A |
| 108 | Gold Concentrate | 208.1 | Natural Polymer B/Coagulant A plus Synthetic Polymer A |
| 109 | Gold Concentrate | 208.1 | Natural Polymer B/Coagulant B plus Synthetic Polymer A |

| | | Flocculant | Time for | Time for | Rate | Rate | % | % | |
|---|---|---|---|---|---|---|---|---|---|
| Example # | Ratio | Dose (g/T) | 30 mLs (s) | 60 mLs (s) | 30 mLs | 60 mLs | 30 mLs | 60 mLs | Average |
| I | 0% | 144.1 | 128 | 477 | 0.24 | 0.13 | | | |
| 95 | 50% | 144.1 | 113 | 429 | 0.27 | 0.14 | 12.8 | 11.1 | 12.0 |
| 96 | 75% | 144.1 | 108 | 416 | 0.28 | 0.14 | 18.1 | 14.6 | 16.3 |
| 97 | 100% | 144.1 | 106 | 397 | 0.28 | 0.15 | 20.3 | 20.1 | 20.2 |
| 98 | 75% | 144.1 | 111 | 421 | 0.27 | 0.14 | 14.9 | 13.2 | 14.0 |
| 99 | 100% | 144.1 | 114 | 436 | 0.26 | 0.14 | 11.8 | 9.3 | 10.6 |
| 100 | 75% | 144.1 | 103 | 399 | 0.29 | 0.15 | 23.8 | 19.5 | 21.6 |
| 101 | 50% | 144.1 | 113 | 421 | 0.27 | 0.14 | 12.8 | 13.2 | 13.0 |
| 102 | 75% | 144.1 | 109 | 408 | 0.28 | 0.15 | 17.0 | 16.8 | 16.9 |
| 103 | 100% | 144.1 | 103 | 386 | 0.29 | 0.16 | 23.8 | 23.5 | 23.6 |
| 104 | 50% | 144.1 | 113 | 424 | 0.27 | 0.14 | 12.8 | 12.4 | 12.6 |
| 105 | 75% | 144.1 | 109 | 399 | 0.28 | 0.15 | 17.0 | 19.5 | 18.2 |
| 106 | 100% | 144.1 | 91 | 338 | 0.33 | 0.18 | 40.1 | 41.0 | 40.6 |
| 107 | 100% | 144.1 | 115 | 424 | 0.26 | 0.14 | 10.9 | 12.4 | 11.6 |
| 108 | 75% | 144.1 | 115 | 428 | 0.26 | 0.14 | 10.9 | 11.4 | 11.1 |
| 109 | 50% | 144.1 | 115 | 432 | 0.26 | 0.14 | 10.9 | 10.3 | 10.6 |

Note
(1) Average of five experiments.

We claim:

1. A method for improving filtration of mining slurries in separating solids from liquids in a two-step process having a physical separation step and a filtration step comprising:
adding to the mining slurry a polysaccharide, a semi-natural polymer, a coagulant, lignosulfonate, a chemically modified polysaccharide and combinations thereof; and one or more synthetic polymers selected from the group consisting of
a. an anionic polymer comprising monomers selected from the group consisting of acrylic acid, methacrylic acid, maleic acid, crotonic acid, itaconic acid, vinyl sulfonic acid, allyl sulfonic acid, 2-acrylamido-2-methylpropane sulfonic acid, acrylamide, combinations thereof and salts thereof;
b. a cationic polymer comprising monomers selected from the group consisting of dialkylamino alkyl (meth) acrylate, acid addition salts of dialkylamino alkyl (meth) acrylate, quaternary ammonium salts of dialkylamino alkyl (meth) acrylate, dialkylamino alkyl (meth) acrylamide, acid addition salts of dialkylamino alkyl (meth) acrylamide, quaternary ammonium salts of dialkylamino alkyl (meth) acrylamide;
c. a nonionic polymer comprising monomers selected from the group consisting of acrylamide, and hydroxyethyl acrylate; and
d. amphoteric polymers provided that there are more cationic groups than anionic groups; thereby forming a multiphase liquid-solid mixture;
separating the liquids from solids of the multiphase liquid-solid mixture using a separation means; and
filtering the liquids from the solids using a filtration means.

2. The method of claim 1, wherein the separation means is a gravity thickener, clarifier or hydrocyclone.

3. The method of claim 1, wherein the filtration means is a filter press or vacuum filter.

4. The method of claim 1, wherein the polysaccharide is selected from the group consisting of potato starch, xanthan gum, guar, dextran, cellulose derivative and glycosaminoglycan.

5. The method of claim 1, wherein the coagulant is an inorganic coagulant selected from the group consisting of aluminum sulfate, aluminum chloride, polyaluminum chloride, aluminum chlorohydrate, ferric chloride, ferric sulfate, ferrous sulfate and sodium aluminate.

6. The method of claim 1, wherein the coagulant is an organic coagulant selected from the group consisting of polymers comprising diallyl dimethyl ammonium chloride, ethylene imine and comonomers of epichlorohydrin and dimethylamine, cationically-modified tannins and melamine formaldehyde.

7. The method of claim 1, wherein the semi-natural polymer is selected from the group consisting of lignosulfonate, chemically modified polysaccharide and combinations thereof.

8. The method of claim 1, wherein the aqueous dispersion comprises a mineral selected from the group consisting of gold, phosphate, silver, platinum, copper, nickel, zinc, lead, molybdenum, iron and coal.
